(19) United States
(12) Patent Application Publication
(10) Pub. No.: US 2004/0084965 A1
(43) Pub. Date: May 6, 2004

(54) Hybrid variable speed generator/uninterruptible power supply power converter

(76) Inventors: Richard Shaun Welches, Amherst, NH (US); Daniel P. Hohm, Nashua, NH (US); Jian Wen, North Andover, MA (US); Kevin E. LeRow, Lowell, MA (US); Richard Griessel, Derry, NH (US)

Correspondence Address: MAINE & ASMUS, 100 MAIN STREET, P O BOX 3445, NASHUA, NH, 03061-3445, US

(21) Appl. No.: 10/691,357

(22) Filed: Oct. 22, 2003

Related U.S. Application Data
(60) Provisional application No. 60/420,166, filed on Oct. 22, 2002.

(51) Int. Cl. H02J 7/00

(52) U.S. Cl. 307/64

(57) ABSTRACT

The invention in the simplest form is an improved hybrid power converter with uninterruptible power supply (UPS) and power quality capabilities as well as an integrated variable speed power source and control method that is used to generate high quality, uninterruptible AC power utilizing fewer batteries and operating at optimum fuel efficiency and with reduced emissions. The variable speed generator control scheme allows for load adaptive speed control of a power source such as an engine and generator. The transformerless hybrid power converter topology and control method provides the necessary output frequency, voltage and/or current waveform regulation, harmonic distortion rejection, and provides for single-phase or unbalanced loading. The transformerless hybrid power converter also provides inline or offline UPS capability, line voltage and/or frequency sag and surge compensation, peak shaving capability, VAR compensation and active harmonic filtering.

### RELATED APPLICATIONS

This application claims the benefit of U.S. Provisional Applications No. 60/420,166, filed Oct. 22, 2002. In addition, this application is related to concurrently filed U.S. Patent Application tbd filed Oct. 22, 2003 entitled Transformerless, Load Adaptive Speed Controller <Atty Docket YOU21A-US>; and U.S. Pat. No. 6,404,655. Each of these applications is herein incorporated in its entirety by reference.

### FIELD OF THE INVENTION

The present invention relates to power generators, power converters and distribution schemes for power distribution. More specifically, the present invention relates to a variable speed energy source with an integrated power conditioning and power quality system and control scheme to generate high quality AC power with optimum efficiency and reduced emissions.

### BACKGROUND OF THE INVENTION

Electric power distribution is a necessary component of systems that operate with electronic power or in the distribution of electronic power. For example, most electronic equipment is connected to a utility grid wherein power arrives in one form and is transferred and transformed into a form more suitable for the equipment.

The distribution of electric power from utility companies to households and businesses utilizes a network of utility lines connected to each residence and business. The network or grid is interconnected with various generating stations and substations that supply power to the various loads and that monitor the lines for problems. Distributed electric power generation, for example, converting power from photovoltaic devices, micro-turbines, or fuel cells at customer sites, can function in conjunction with the grid. Loads that are connected to the grid take the generated power and convert it to a usable form or for supplementing the grid.

An electric utility grid generally can also consist of many independent energy sources energizing the grid and providing power to the loads on the grid. This distributed power generation is becoming more common throughout the world as alternative energy sources are being used for the generation of electric power. In the United States, the deregulation of electric companies has spurred the development of independent energy sources co-existing with the electric utility. Rather than have completely independent energy sources for a particular load, these alternative energy sources can tie into the grid and are used to supplement the capacity of the electric utility.

The number and types of independent energy sources is growing rapidly, and can include photovoltaic devices, wind, hydro, fuel cells, storage systems such as battery, super-conducting, flywheel and capacitor types, and mechanical means including conventional and variable speed diesel or IC engines, Stirling engines, gas turbines, and micro-turbines. In many cases these energy sources can sell the utility company excess power from their source that is utilized on their grid.

Each of these independent energy sources needs some type of power converter that feeds energy to the grid or used to directly power the various loads. There must also be some means to provide protection when the grid becomes unstable. In most scenarios the utility company is still the main power source and in many cases controls the independent source to some extent.

A problem with the present systems is that typical internal combustion (IC) engine generator systems must rotate at a fixed speed to provide a fixed frequency output. This dramatically limits the engines maximum output or overload power, decreases part-load fuel efficiency, and consequently increases emissions/KWhr of power produced.

Another problem with the state of the art systems is that the distribution system is subject to non-linear, high harmonic content and unbalanced loading. This is especially true where the distributed generation system operates independent of the utility grid, and must therefore provide all of the load required harmonic currents. In distributed power applications, high harmonic content or unbalanced loads may lead to utility grid instability, resonances or other unanticipated distribution system behavior that may cause catastrophic failure of the distribution system components. Such a failure can result in damage to equipment and possibly personal injury.

Another problem with existing systems is that UPS systems typically require a large number of batteries (5-20 minutes at full load) to provide energy storage and which must be replaced frequently. Further, most UPS systems require “add-on” modules to provide for line voltage sag and surge. Also, VAR compensation and active filtering (active harmonic elimination) is typically not provided by existing UPS systems but by a different power electronics system altogether.

Power converters, such as inverters, are necessary in modern power systems and especially for the new energy generating devices such as photovoltaic devices, micro-turbines, variable speed internal combustion (IC) engines, fuel cells, and superconducting storage. These devices generate AC or DC electricity that needs to be converted to a conditioned AC for feeding into the power grid or for direct connection to loads.

Grid independent DC-AC inverters generally behave as sinusoidal voltage sources that provide power directly to the loads. This type of power distribution architecture is generally required to provide power to both 3-phase and single-phase, or line to neutral connected loads. Typically, 3-phase power inverters meet this 3-phase plus neutral requirement by isolating the power inverter from the loads with a delta-wye power transformer. This is an inferior method of providing a neutral in that the transformer cost, size, weight, inefficiency (losses), and output impedance all increase. Thus the power quality and efficiency are negatively impacted and may even require de-rating for typical harmonic loads.

Grid connected AC inverters generally behave as a current source that injects a controlled AC sine wave current into the utility line. The controlled AC current is generated in sync with the observed utility zero crossings, and may be exactly in phase, generating at unity power factor where upon real power only is exported. It is also possible to generate a variable amount out of phase—at other than unity power factor where upon real and reactive power is exported to the grid. An effective change in reactive power output can be made by either phase shifting the output current waveform with respect to voltage or by creating an asymmetric distortion to the output current waveform.

Whether grid connected or grid independent, typical generators demonstrate poor output waveform total harmonic distortion (THD) when connected to any non-linear loads. This is particularly true in the case of even order harmonic currents (2^{nd}, 4^{th}, 6^{th}, 8^{th} etc.). Specifically, typical generators and power transformers common to most power distribution systems demonstrate a tendency to saturate especially when exposed to even order or DC content, load generated non-linear currents. This causes the generator output voltage waveform to rapidly degrade while simultaneously increasing generator losses and operating temperatures, and decreasing the power actually coupled from the engine to the electrical load. A variety of factors define how steep this saturation transition will occur, including magnetic core material and construction, magnitude and frequency of harmonics, and generator operating temperature. At the least, very poor output power quality, nuisance circuit breaker tripping, increased distribution system components loss and increased operating temperatures will be observed.

Although generator or transformer saturation is not as likely to occur in utility grid connected systems (due primarily to the utility grid's typically lower impedance than the grid connected inverter system), distortion and instability may still occur. This problem is greatly aggravated where generators, or transformer isolated power inverters act as “stand alone” voltage sources, where the generator or inverter comprises the only power source to the local distribution system.

These problems are currently solved in the distribution system by over sizing the generator or distribution transformers. For power inverters, expensive gapped core type isolation transformers are commonly employed to decrease the power conditioning system susceptibility to even order harmonic currents, as well as isolate inverter generated DC voltage offsets from the distribution system. This approach helps, but does not completely solve these problems. The increased cost, losses, size and weight requirements for the isolation transformers are problems that are well known in the industry.

Inverters that perform an AC conversion function, and are connected to the grid, are known as “Utility-Interactive Inverters” and are the subject of several US and international codes and standards, e.g., the National Electrical Code, Article 690—Standard for Photovoltaic Inverters, IEEE 929—Recommended Practice for Utility Interface of Photovoltaic (PV) Systems, IEEE1547, UL 1741, and IEEE 519.

Pulse width modulator (PWM) inverters are used in three phase bridges, H-bridges, and half-bridge configurations. The bus capacitors, typically electrolytic, consist of two or more capacitors connected in series that are fed from a passive rectifier or actively switched front end section.

In order to reduce the aforementioned problems, attempts have been made to produce an improved generator speed control and electronic power dispensing system. The state of the art systems have general short-comings and do not adequately address the aforementioned problems. For example, the state of the art systems employ a UPS with switching gear hanging on the line along with a generator/engine with switching gear hanging on the line wherein the units are not cooperatively communicating. Another configuration known in the art has the UPS inline with the AC line input and the generator/engine is located after the UPS such that the generator/engine are directly coupled to the load when the line power fails.

What is needed is a means of providing a low cost, Hybrid VSG/UPS power conditioning system, with all of the required power quality capabilities, reduced electrical energy storage requirements, ideally combined with an efficiently operated variable speed generator which, is operated at the optimum engine speed for a given load. This speed versus load curve may be optimized to develop the lowest possible emissions, highest possible efficiency, or even to provide the fastest transient response, or highest overload capability. It is also possible to use a “standard” fixed frequency, fixed rpm generator combined with the Hybrid UPS power conditioning system and thereby still provide all the power quality and UPS capabilities, although the benefits of VSG technology such as fuel efficiency and noise reduction etc. are lost. This design must also be cost effective to manufacture and implement, and allow for easy incorporation into current designs.

### BRIEF SUMMARY OF THE INVENTION

While adaptable in many forms, the invention is a variable speed energy source with an integrated power conditioning and power quality system and control scheme to generate high quality AC power with optimum efficiency and reduced emissions. Further the power conditioning/power quality system and control scheme provides for inline and offline uninterruptible power supply (UPS) operation, line voltage sag and surge correction, generator backup power (as either a voltage source or grid connected current source), peak shaving, VAR compensation and active filtering and active harmonic elimination.

The present invention has been made in consideration of the aforementioned background. In one embodiment the present invention provides a Hybrid VSG/UPS power conditioning system which provides inline and offline UPS capability with reduced electrical energy storage requirements (10-15 seconds of battery power), line voltage sag and surge correction, peak shaving capability, VAR compensation and two methods of active filtering (active harmonic elimination) ideally combined with a power source such as a variable speed generator. In addition to providing UPS and power quality capabilities this invention also allows for improved variable speed engine operation, and has all the benefits of a power conditioning system including power factor correction of the generator output, more efficient generation of power, lower audible noise, and lower emissions, especially when operated at part-load.

In one embodiment the hybrid power converter apparatus, comprises a variable speed energy generating device producing differing amounts of power at different speed, with a hybrid uninterruptible power supply coupled in-line between an AC line and a load, wherein the hybrid uninterruptible power supply is switchably coupled to the variable speed energy generating device, and wherein the hybrid uninterruptible power is comprised of a regulator section coupled to an inverter and an energy storage module coupled therebetween.

The inverter can be selected from the group consisting of: transformerless AC pulse width modulator inverter, DC-AC inverter, static inverter, rotary converter, cycloconverter, and AC-AC motor generator set. The variable speed energy generating device can be selected from the group consisting of: internal combustion engine, turbine, micro-turbine and Stirling engine. The regulator section can be an enhanced conduction angle dual boost DC bus voltage regulator.

The apparatus can include a switch between the inverter and the load. There can also be switch coupling the hybrid uninterruptible power supply to the AC line. The energy storage module can be selected from the group of devices consisting of batteries and flywheel.

The apparatus can further comprise a bypass switch coupling the AC line to the load wherein the bypass switch is a bi-directional thyristor. A bypass switch can also couple the variable speed energy source to the load.

A further embodiment is a method for providing uninterruptible AC power to a load, comprising coupling an AC line to a hybrid uninterruptible power supply, coupling the hybrid uninterruptible power supply to the load, wherein the hybrid uninterruptible power supply comprises a regulator section, an inverter and an energy storage module, and switchably coupling a variable speed energy source to the hybrid uninterruptible power supply.

The process can further comprise feeding the hybrid uninterruptible power supply with the energy storage module, wherein the feeding can be derived from a load shed term. In addition, the steps can include charging the energy storage module while simultaneously providing output power to the load. The method can further comprise steps selected from at least one of the steps consisting of: correcting for sag, correcting for surge, peak shaving, compensating for VAR, active filtering and elimination of active harmonics.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1a: Prior art configuration of UPS and genset with UPS and genset independently coupled to the AC line.

FIG. 1b: Prior art configuration of UPS coupled to the AC line and having the genset tied to the line.

FIG. 1c: Simplified diagrammatic perspective of the present invention wherein the variable speed power source is coupled to the UPS which in turn is coupled to the line.

FIG. 2: Simplified block diagram of Hybrid VSG/UPS system with inline UPS capability, line voltage and/or frequency sag and surge compensation, and a variable speed generator.

FIG. 3: Block diagram of Hybrid VSG/UPS system with inline UPS capability, line voltage and/or frequency sag and surge compensation, offline UPS capability via thyristor bypass switches and variable speed generator.

FIG. 4: Block diagram of Hybrid VSG/UPS system with inline UPS capability, line voltage and/or frequency sag and surge compensation, offline UPS capability via thyristor bypass switches. Peak shaving, VAR compensation, and active filtering capability where the line is closed to the load via switch 3, and the Hybrid VSG/UPS with variable speed generator connected to the load via switch 1a and switch 4. Also allows for system bypass by closing switch 3, and opening switches 1B and 4.

FIG. 5: Block diagram of Hybrid VSG/UPS system with inline UPS capability, line voltage and/or frequency sag and surge compensation, offline UPS capability via thyristor bypass switches. Peak shaving, VAR compensation, and active filtering capability where the line is closed to the load via switch 3, and the Hybrid VSG/UPS with variable speed generator connected to the load via switch 1a and switch 4. Also allows for system bypass by closing switch 3, and opening switches 1B and 4. Also provides for genset backup in system bypass by closing switch 2 with all others open.

FIG. 6: Detailed block diagram of one embodiment VSG system with speed versus load controller depicted in the simplified primary speed command generator. The primary speed command generator resides in the digital signal processing (DSP) VSG card.

### DETAILED DESCRIPTION OF THE INVENTION

The present invention is adaptable in many forms but essentially provides an uninterruptible power supply (UPS) with power conditioning qualities. As an in-line or off-line UPS, the device handles voltage sag, voltage surge, peak shaving, VAR compensation and active filtering—plus VSG control.

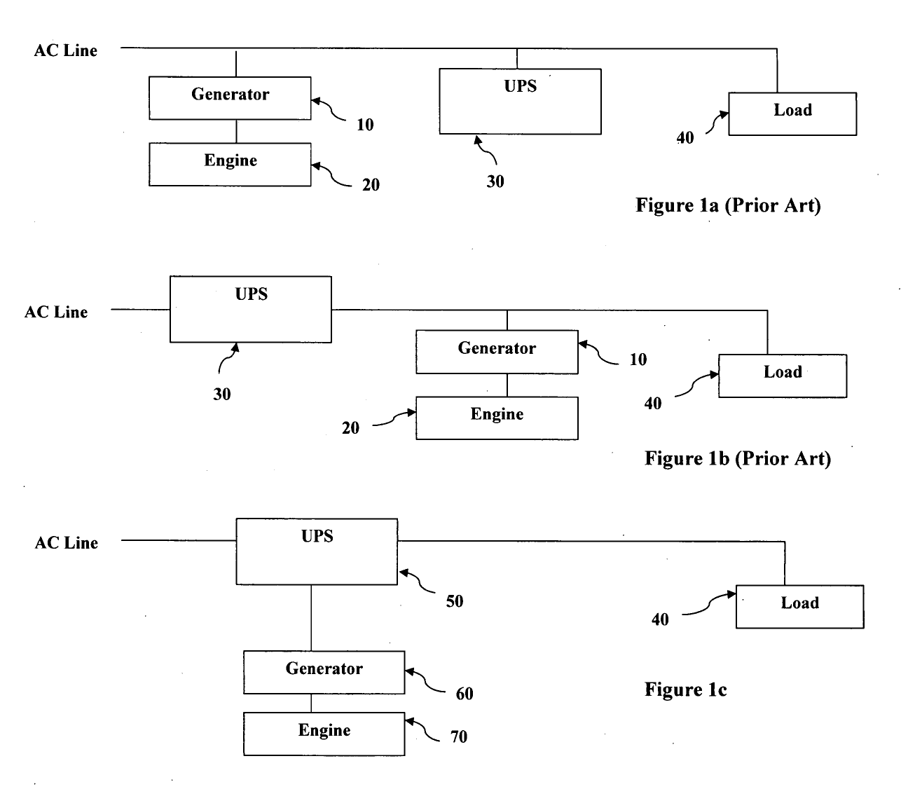

Referring to FIG. 1a, the prior art UPS implementation is depicted with the generator 10 and engine 20 coupled together and tied to the AC line. The UPS 30 is independently coupled to the line, and the load 40 is also tied to the line. There are independent switching gear that is used to couple the generator/engine 10/20 to the line and the UPS 30 to the line. If the line power fails or is at an unacceptable level, the UPS 30 would be switched online and provide power for some small period of time that would allow the engine to start up, sync up, and come online. Once the genset 10/20 is functional, the UPS 30 would be disconnected from the line and the output of the generator 10 would directly feed the load 40.

A different prior art configuration is shown in priori art FIG. 1b, wherein the UPS 30 is inline with the AC line and the generator/engine 10/20 is tied to the line through some switching gear as is known in the art. Once again, in the event that the AC line fails, the UPS 30 would supply power to the load while the engine was started and was able to come up to power to replace the AC line. The output of the generator 10 directly feeds the load 40.

Referring to FIG. 1c, a simplistic view of the present invention is depicted. In this example, the UPS 50 is tied to the AC line and the engine 70 and generator 60 are coupled to the line through the UPS 50. The UPS 50 not only performs the UPS function, it also controls the generator/engine 60/70 and conditions the output prior to reaching the load 40. The engine/generator in this embodiment is a variable speed power source wherein the UPS 50 adjusts the speed of the source according to the load requirements.

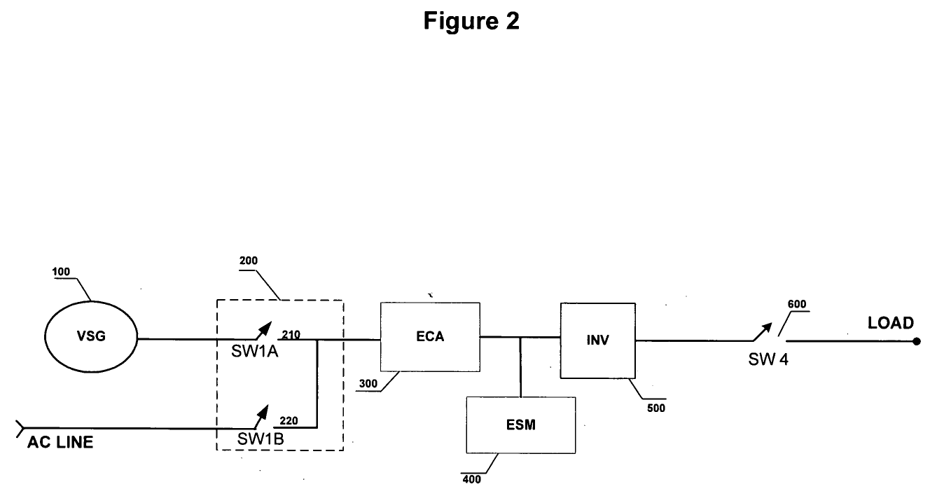

The Hybrid VSG/UPS in one embodiment is shown in FIG. 2, and provides inline UPS capability and line voltage and/or frequency sag and surge correction as well as improved variable speed genset backup power to the load. Normally switch 1B (220) and switch 4 (600), are closed for line power connection. The AC line power is fed to the power converter enhanced conduction angle ECA 300 via switch 1B (220), where it is power factor corrected, rectified and the voltage is boosted to a regulated DC voltage. The ECA 300 has the additional advantage of synchronizing of the power. The output inverter 500 takes power from the ECA input 300 and develops a transformerless 3-phase (4-wire) AC output to the load via switch 4 (600), either as a voltage source or a grid connected current source.

If the line voltage and/or frequency deviates from nominal the power converter ECA input 300 remains automatically synchronized to any frequency, and corrects for line voltage drift by boosting either more or less, whatever is required to keep the DC output to the inverter 500 constant. Thus line voltage and/or frequency sag and surge correction is provided. The inverter 500 is always connected to the line and in-phase (even when in bypass mode) so that it measures the characteristics for compliance with the acceptable range limits. For example, typical limits of +/−10% would establish the conditions for using the energy storage module (ESM) for short duration intervals awaiting recovery of the AC line. While the limits are arbitrary, there is a limit such that boosting of a sagged line would draw too much current for the system.

The Hybrid VSG/UPS requires only 10-15 seconds worth of energy storage, (typically batteries), as the generator may be started and begin to produce power within 10 seconds. Thus, less than 5% of the amp/hours required by a “5 minute UPS” are required by the Hybrid VSG/UPS. This reduces UPS size, weight, installation and battery replacement costs

The Hybrid VSG/UPS shown in FIG. 2 also provides for inline UPS with a truly seamless transition from line power to batteries and then to the variable speed power source such as the genset. In this implementation, the transfer between the UPS and variable speed power source requiring a fraction of the electrical storage, such as batteries, normally provided by existing UPS's. In a typical “line loss” where the line is outside an acceptable range, completely off, or even missing a phase, the ESM 400 which, typically consists of storage batteries and a DC/DC converter, will contribute power (regulated DC voltage) to the inverter 500 input DC bus for up to 3-5 seconds, thereby allowing for continuous un-interrupted operation of the inverter 500. If the line remains outside an acceptable range, completely off, or missing a phase for longer than 5 seconds, switch 1B (220) opens, switch 1A (210) closes, the engine-generator is started and begins to provide power to the power converter ECA 300. At this point the output inverter is supplied power from the ECA 300 which also begins to re-charge the ESM 400.

When applied to variable speed engine-generators the Hybrid VSG/UPS also allows the VSG to react to step loads without “shedding load” or decreasing “sagging” the inverter 500 output AC voltage. This is accomplished by allowing the ESM 400 to supply power to the load via the output inverter 500, while the engine is sped up to a higher RPM where the engine can then produce more power. This allows the VSG to be operated at it's optimum speed versus load point (no engine power margin/RPM's needs to be held in reserve), while still providing seamless AC output power from the inverter 500, with no voltage sag, or load shedding required.

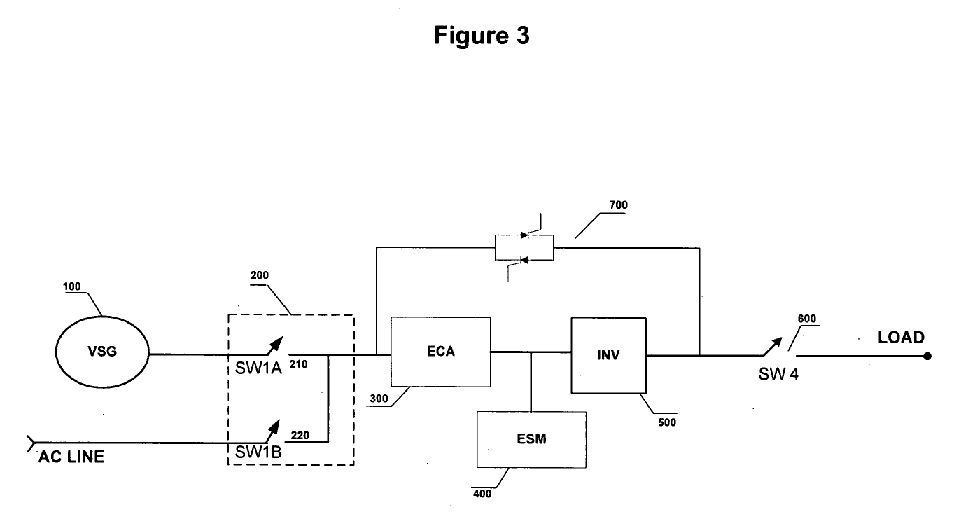

The Hybrid VSG/UPS depicted in FIG. 3 includes the addition of a 3-phase, bi-directional thyristor bypass switch 700. This configuration of the HYBRID VSG/UPS provides all the features and benefits described above for FIG. 1 in addition to VAR compensation, offline UPS, and active filtering (harmonic elimination). The thyristor switch 700, the line power to be fed to the load via closed switches, 1B (220), thyristor bypass switch 700, and switch 4 (600). This greatly reduces losses and provides 99%+ efficiency. When configured in this manner it is possible for the output inverter 500 to connect to the line as a current source, and inject VAR's of an adjustable magnitude, thereby providing resonant free VAR compensation while awaiting any command to go to UPS mode. 10048 When the Hybrid VSG/UPS is configured as described above, offline UPS capability with less than ¼ cycle response time is provided. If the line voltage or frequency drift outside a selected window, the thyristor bypass switches 700 are opened, and the ECA 300 will begin to draw power from the line, rectifying and boosting the voltage that is then supplied to the output inverter 500 which now acts as a voltage source to feed the load. This provides voltage and frequency sag and surge correction. If the line continues to drift farther outside a maximum selected acceptable range or window, or the line goes completely off, or is missing a phase the ESM 400 will provide power to the DC bus for 3-5 seconds. If the line is not corrected within that time, Switch 1B (220) opens, switch 1A (210) closes and the engine-generator 100 is started. Power is then provided to the ECA input 300 and then used to feed the output inverter 500, and recharge the ESM module 400. Thereby providing offline UPS capability with engine generator backup.

Active filtering (harmonic elimination) can be accomplished when the line is connected to the load via switch 1B (220), the thyristor bypass switches 700, and the output switch 4 (600). When configured in this way, the output inverter 500 synchronizes to the line voltage and connects to the line as a current source. The current command is generated by observing the harmonic currents flowing through the thyristors 700, the line currents. The current command generated is fundamentally equal and opposite to the currents observed on the line. Simultaneously it is possible to self adjust the output inverter 500 currents, and their phase angles accomplish VAR compensation.

Further, if the power converter was to fail, it is possible to run the engine generator 100 at a fixed frequency and voltage, and feed power to the load by closing the bypass thyristors 700, switch 1A (210) and switch 4 (600). It is also possible for the line to feed the load by closing switch 1B (220), opening switch 1A (210), closing the bypass thyristors (700), and closing the output switch 4 (600).

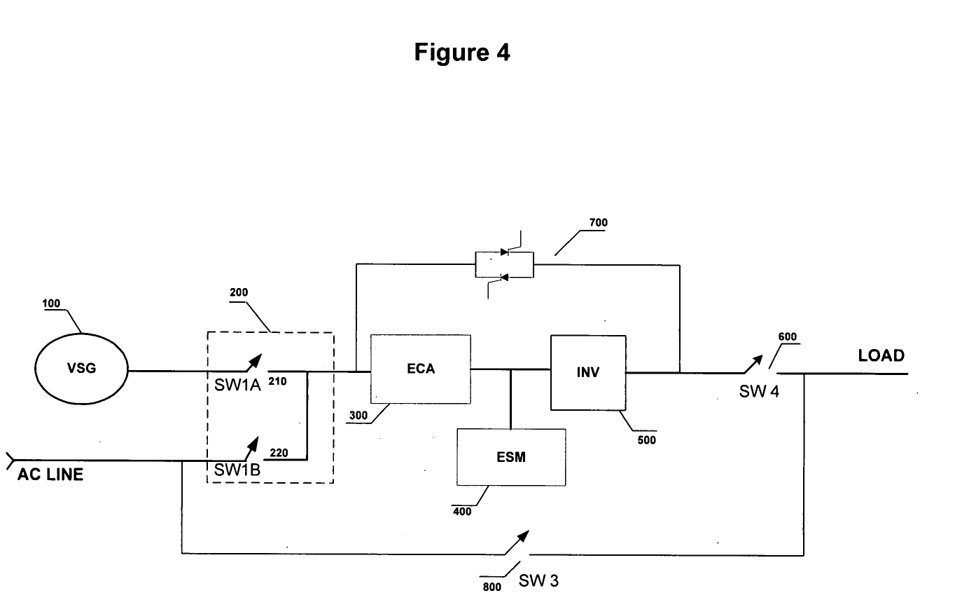

The Hybrid VSG/UPS depicted in FIG. 4 includes the addition of a 3-phase system bypass switch, switch 3 (800). This configuration of the Hybrid VSG/UPS provides all the features and benefits described above for FIG. 2 and FIG. 3 in addition to allowing peak shaving and also allowing the line to completely bypass the entire power converter (300, 400, 500), the engine generator 100, and thyristor bypass switches 700 as well. This allows for maintenance of all portions of the Hybrid VSG/UPS without interrupting power to the load.

For peak shaving applications, the Hybrid VSG/UPS closes the line to the load via switch 3 (800), switch 1B (220) is open, and switch 1A (220) is closed. The engine generator is then started and feeds power to the ECA input 300 where it is rectified and boosted, and then fed to the output inverter 500. The inverter synchronizes to the line, closes switch 4 (600) and connects to the grid as a current source. This allows the output inverter to inject the commanded amount of power into the grid to accomplish peak shaving, thereby saving customers from costly “peak demand” charges. A further advantage to this approach is that the output inverter 500 can rapidly respond to transient loads. It can also be made to drive current at unity power factor or with leading or lagging power factor to accomplish VAR compensation simultaneous to peak shaving. It is possible for the output inverter 500 to directly observe the line currents, and self adjust the amount of output power required to meet a pre-selected maximum peak threshold set for the load.

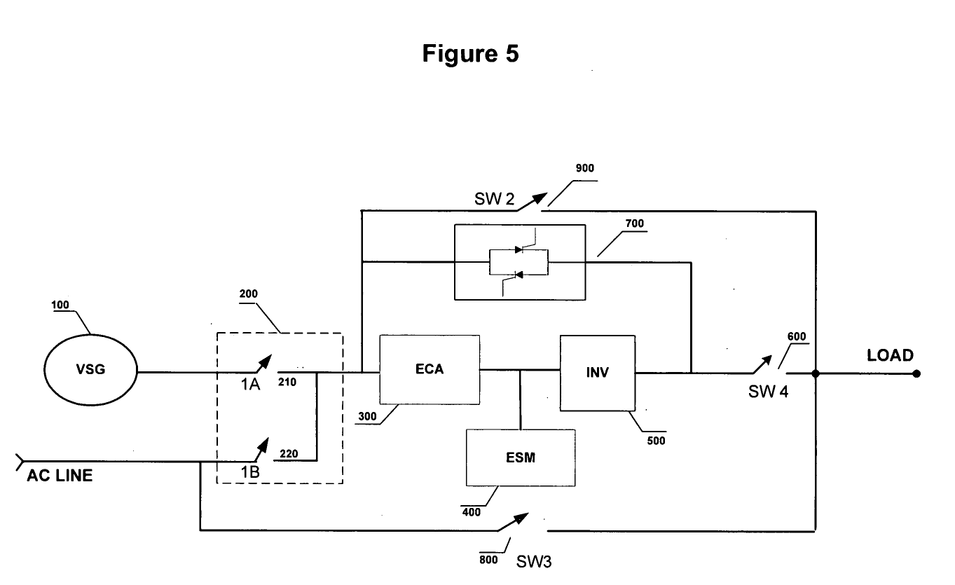

FIG. 5 is a block diagrammatic overview of one embodiment of the Hybrid VSG/UPS system depicting basic system topology and interconnect scheme. The Hybrid VSG/UPS system in this embodiment is comprised of a transformerless AC PWM inverter and control 500, an enhanced conduction angle dual boost DC bus voltage regulator and control 300, an ESM (energy storage module) 400, a synchronous generator (optionally a PMM type generator) with and IC (internal combustion) engine 100, with an input power transfer switch 200, 210, 220, a fast thyristor bypass switch 700, an inverter output switch 600, a total line to load system bypass switch 800, and a genset to load system bypass switch 900.

The hybrid VSG/UPS depicted in FIG. 5 includes the addition of a 3-phase power converter bypass switch, switch 2 (900). This configuration of the Hybrid VSG/UPS provides all the features and benefits described above for FIG. 1, FIG. 2, and FIG. 3 in addition to allowing the engine generator 100 to operate at a fixed frequency and voltage and provide power to the load in case of a total line power loss, and power converter failure. In this example, Switch 1B (220) is opened, switch 1A (210) is closed, switch 2 (900) is closed and switch 4 (600) remains open. Thus we can still provide power to the load even if the line is off, the power converter 300, 400, 500 has failed, and the bypass thyristors 700 fail to turn on.

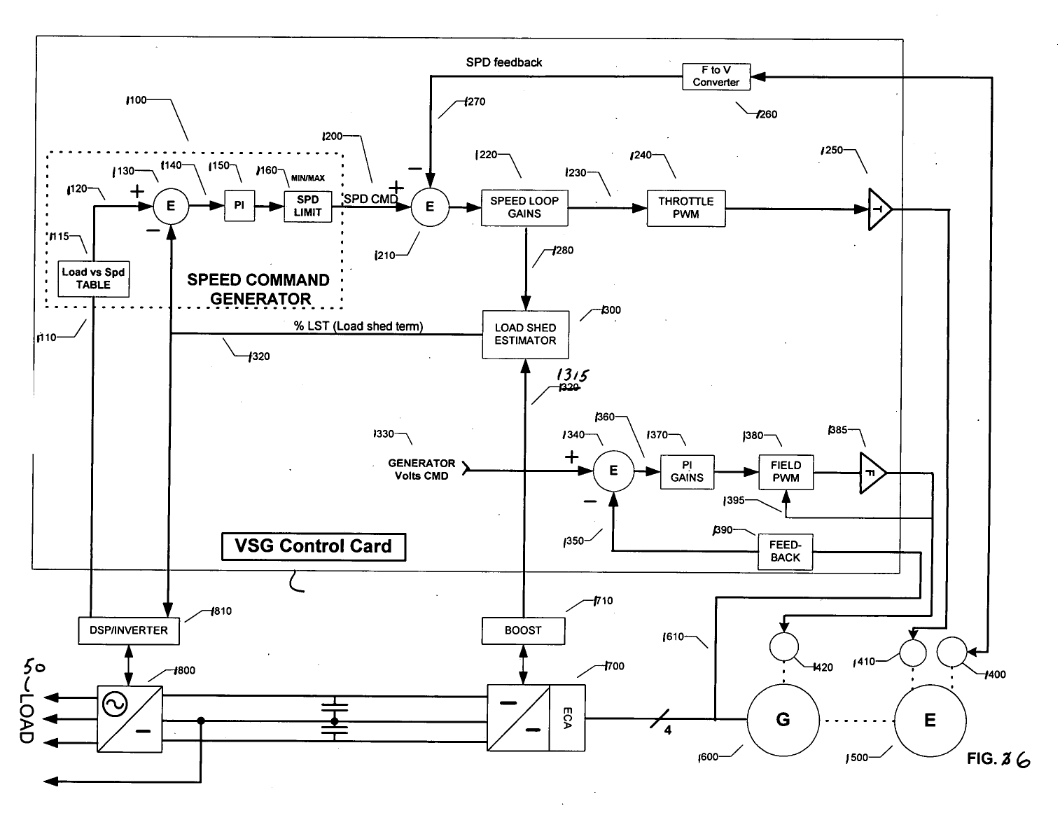

FIG. 6 is a block diagrammatic overview of one embodiment of the VSG system depicting basic system topology and control scheme. It should be understood that while depicted in an analog fashion for clarity, the actual invention can be implemented with a digital DSP that is more flexible. The VSG is comprised of a transformerless AC PWM inverter 1800 and AC PWM control 1810, an enhanced conduction angle (ECA) dual boost DC bus voltage regulator 1700 and ECA dual boost voltage regulator control 1710, a generator 1600 with an optional field winding 1420 for synchronous type, an internal combustion (IC) engine 1500, with an electromechanical throttle actuator 1410, and a speed feedback magnetic pickup 1400. The speed feed back come in other various forms, such as tachometers and back EMF generators.

The VSG engine primary “speed command generator” block 1100, receives actual output power feedback 1110, from the PWM inverter processor 1810. In this example, the speed versus load user-programmable lookup table is represented by block 1115. The lookup table contents are pre-programmed points that make a curve of optimum engine speed versus load for a given application. The table values selected will vary based on the specific VSG and the type of application. Foe example, the table can be implemented based upon maximum fuel efficiency, minimum emissions, and optimum transient load response. The VSG engine secondary “speed command generator” resides in the DSP/INVERTER 1810, and is only used for extreme load transients.

The inverter control 1810 calculates each AC phase current, voltage and phase angle and sends the actual “real” power out signal 1110 to the lookup table 1115 where the inverter power out signal drives the lookup table pointer. Thus the actual load defines, according to the selected table, the optimum engine speed for a given “actual load power”. The output of the data table 1115 is the “indicated speed reference” 1120, and is connected to the summing amplifier 1130. This signal is summed with the LST (load shed term) 1320, at summing amplifier 1130, the output of which 1140 is the “desired engine power/speed” which is proportionate to the requirement for full output power. The desired engine power/speed 1140 indicates the actual AC power out plus the power being shed by the LST signal 1320, thereby yielding the amount of power and engine speed required to achieve a no load shed condition for full output AC voltage and thus full load required power.

The desired power/speed signal is sent to the proportional integral amplifier 1150 where it is amplified and then sent through the VSG engine speed limiter block 1160. The maximum and minimum speed limits are programmed limits from the DSP, appropriate to the specific engine/generator safe limits. The output of 1160 is the actual speed command 1200.

The speed command 1200 is summed with the speed feedback 1270, from the frequency to voltage converter 1260, which, receives engine speed feedback from the magnetic pick up (MPU) 1400. Alternative speed sensors, such as zero crossing detectors connected to the generator magneto, or tachometers are also within the scope of the invention. One of the outputs of the PI speed summing amplifier 1210, the speed error signal, is fed to the speed PI loop gain amplifier 1220 where it is amplified and sent to the engine throttle valve actuator 1400 via PWM amplifier 1250.

The proportional portion of the PI speed summing amplifier 1210 may also be fed to the load shed estimator 1300, where it may be summed “optionally” with the “percent beneath current limit” signal 1320, from the DC/DC dual boost regulator control 1710. The load shed estimator 1300 consists of an independent PI amplifier for each input signal 1280 and 1320, the outputs of which may be summed together to provide the LST (load shed term) 1320.

The load shed term 1320 is fed to the PWM inverter controller, wherein the AC voltage command is reduced to adjust the output AC PWM voltage PWM signals sent to the inverter power stage 1800, for the purpose of shedding VSG engine/generator 1500/1600 load by decreasing output AC voltage. The LST (load shed term) 1320 is also fed to the speed command generator 1100, for use in calculating the desired power out 1140 as follows:

AC power_{actual}−(−AC Power_{LoadShedTerm})=AC power_{desired}

During fast transient, or “step loads”, the load shed estimator 1300 detects a sudden decrease in engine speed. If this decrease in engine speed reaches a predetermined magnitude, a change in the load shed term 1320 is detected by the inverter DSP 1810 which instantaneously sheds load power—the output AC Voltage—based on the current engine speed and output power. The amount of load shed is selected by the secondary speed command generator located in the DSP/Inverter 1810, such that the engine 1500 has adequate “power margin” to accelerate the engine to a higher speed/power operating point while minimizing the voltage sag. To allow time for an accurate power calculation, the inverter DSP 1810 also sets the engine speed command to the maximum speed. Once approached, the output AC voltage is then quickly ramped back up, and the precisely calculated load power is then used to select the optimum engine operating speed by the primary speed command generator 1100 via the load versus speed table 1115. The power curves for engines and other power sources are well known to those skilled in the art

The load versus speed curve can be digitally selected to follow a user adjustable multi-point curve, or one of the pre-programmed engine specific maximum efficiency, minimum emissions, minimum audible noise, or optimum transient recovery curves. Further operational modes include the load versus speed curve for a general engine with auto seek mode capability. The auto seek mode allow the generator speed to drift up and down slowly away from the preprogrammed value (within a pre-defined band), while seeking the optimum gains for stability, or fuel efficiency speed for a given load. Although ideally applied to EFI controlled engines, it is also possible to use fuel flow provided by a fuel flow sensor or even to estimate fuel flow based on throttle position, air temperature and engine RPM.

In one embodiment the control printed circuit board (PCB) of the present invention acts as a digital signal processor (DSP) based digital controller, in concert with some analog control circuits. Both the minimum and maximum engine speed limits are digitally selected. The load shed term (LST) and the speed control loops have digitally (or analog) selected proportional and integral terms, and the feedback circuits have analog phase lead and filter circuits for optimum system tuning. Thus, precise closed loop transient performance is accomplished.

A further aspect of the invention is to provide electronically controlled current limiting. This allows the VSG to start and run very difficult, high overload type loads, such as induction motors. This is another method of output power limiting, in addition to power limiting from LST commanded voltage decreases which, provide VSG engine power management. The LST is a somewhat “slow” signal based more on VSG engine time constants, hence it is not fast enough to prevent over current type faults in the PWM inverter, for some vary rapid onset transient overloads. For this purpose, the PWM inverter uses AC output PI current loops which are invoked during overload current conditions and are utilized to limit rapidly increasing AC currents due to instantaneous load changes such as “motor starts”.

In one implementation of the present invention the VSG engine may be operated at a programmable speed above the minimum that is required to meet the load. Thus, an offset speed command may be selected to provide for a reasonable margin or head room of engine power to be available for moderate step changes in load. This allows the user to select more “offset speed” or engine power margin to respond to load transients by adjusting the throttle only, thereby eliminating or minimizing the amount of load shedding required to allow the VSG to accelerate to the new load defined speed set point.

Conversely, less speed offset may be selected to enhance efficiency by operating the VSG very close to the speed required to provide output power only. This somewhat compromises the VSG's ability to adjust to transient loads by increasing the magnitude of load shedding required, but this may be less important than maximum efficiency in some applications.

The present invention also provide a means whereby total power output may be quickly and accurately estimated based on the PCS DC Amperes and Volts and/or the AC amps, volts and phase angles and used to provide power feedback to the VSG controller speed command generator circuit. During load shed conditions the load shed term is summed with the actual power out feedback. This provides a composite total “desired power” feedback signal that is used by the VSG speed control where it is compared to a look up table so as to derive the optimum speed command. Different pre-defined look up tables may be stored in the DSP memory which may include different load versus speed profiles for each VSG engine generator set and are optimized for the application; whether for emissions reduction, efficiency enhancement, transient load capability, audible noise reduction, or UPS functionality.

An additional feature of the invention is to provide a closed loop generator voltage regulator, or field control (for synchronous type as opposed to PM type, VSG generators). The field control may be superceded by load shedding commands (normally fed to the output inverter) wherein the generator phase voltages are allowed to collapse to limit VSG load. Additionally, the DC boost stage may also be actively “current limited” to shed load.

The invention also provides a means for limiting the PCS inverter AC currents to accomplish load shedding. This is particularly true for PM (Permanent Magnet) type generators wherein no field control is available to provide control of generator BEMF. Thus the PM type VSG accomplishes load shedding primarily by reducing the PWM inverter's output AC voltages.

Generator 1600 voltage regulation is accomplished by adjusting the field voltage 1420 in synchronous type VSG generators. A programmed AC voltage command (GENERATOR Volts CMD) 1330 is provided to the field regulator where it is summed at amplifier 1340 with the generator 3-phase AC voltage feedback signal 1610, via rectifying feedback amplifiers 1390. This provides a DC feedback signal 1350 that is summed with AC voltage command 1330, at summing amplifier 1340. The resulting generator voltage error signal 1360 is fed to the PI (proportional integral) amplifier 1370, where it is amplified and connected to the field PWM stage 1360. The output of the field PWM stage is connected to the generator field winding via PWM amplifier 1385. The field PWM stage 1360 also incorporates a current limit function which receives DC current feedback from 1395 (shunt resistor with amplifier). This function is used to protect the field PWM amplifier from overloads and also may be allowed to shed generator loads by limiting field current.

In VSG's with PM (permanent magnet) generators no adjustment of the generator back electromotive force (BEMF) is possible, however, all other VSG control techniques described herein still apply. Other types of generators may apply with different types of front end power circuits 1700, 1710, for example induction or even DC generators. Because of the inherent boost capability of the ECA “AC to DC converter”, even very low generator voltages may be boosted up to a usable level.

The present invention provides a regulated high quality fixed frequency, low THD, 3-phase/3-wire, or 3-Phase/4-wire (includes neutral phase), AC power output to a load for the efficient conversion of power from a power source such as a variable speed variable frequency generator. In addition, the invention provides single-phase/2-wire or single-phase/3-wire (includes neutral phase) AC power output to a load.

The invention provides automatic regulation of the generator at the optimum speed/frequency and voltage for a given load such that excessive frictional, pumping, windage and other parasitic engine losses are not incurred, especially when feeding relatively light loads.

The additional benefits of connecting a generator to a load through a Power Conditioning System (PCS) include isolation of the generator from load induced harmonics and imbalances (unequal or non sinusoidal loads on each phase); improved output voltage regulation; lower output impedance; simplified interconnection to the grid; faster fault shutdown with inherent reduction of 'short circuit or fault currents”; and the ability to provide synthetic “soft-starting” of transient loads. Further benefits include the PCS mitigation of load reactive power requirements, such that the generator provides power only at near-unity power factor regardless of load reactance.

A further aspect of the invention is that while operation at reduced engine/generator speed is much more efficient and audibly quieter, it does deprive the engine/generator of the additional power overhead required to maintain speed and simultaneously source power to an instantaneously applied increase in load or a “step load”. Without an energy storage module (ESM), the VSG power converter typically increases the throttle command (fuel supply). However, in certain instances increasing the throttle alone may be inadequate to prevent an engine stall. Another option to handle the step load is to shed a portion of the engine/generator load, which corresponds to a sag in the output voltage, long enough so that the engine/generator may be accelerated to the optimum speed for the new load conditions. Since torque multiplied by speed equals power, it follows that operation at a higher speed allows for more power from an engine (up to a maximum RPM, for a given engine). A Hybrid VSG/UPS power conditioning system with an integral energy storage module allows the transient load to be fed entirely from the ESM thereby allowing the engine generator to quickly reach a higher RPM and totally eliminates the need to “shed load” and sag the output voltage.

Modem combustion engines used for power generation are typically at the bottom of their “power” curve when operated as a fixed speed generator (typically 1800 rpm), it is possible to provide greatly increased power output by simply increasing engine speed. There is of course a limit as the frictional, windage, and pumping losses increase with the speed (often exponentially). The opposite is also true for decreases in speed. Thus, it is possible to realize efficiency gains as well as emissions reductions by reducing the operating speed to the minimum which is required to feed a given load. (While simultaneously feeding engine losses).

The present invention operates with a traditional fixed speed generator while still providing all of the UPS and power quality features and capabilities.

The present invention also allows for energy storage modules of virtually any type to be used, including batteries, flywheels, supercapacitors or any other source of power which may be converted into a regulated DC voltage for use by the output inverter.

An additional aspect of this invention is a high “power quality” type application where an additional energy storage module (ESM) is connected to the power conditioning system DC bus link. This provides for rapid sourcing of power from the ESM to the transient load, thereby shedding load from the VSG while allowing time for the VSG to settle at the new “load defined” optimum speed. The local ESM allows quicker engine response to occur by providing energy to the load while the engine/generator is climbing to the new speed set point, thus, no output voltage sag (load shed) is required.

This invention also encompasses a means whereby total power output may be quickly and accurately estimated (based on the PCS DC Amperes and Volts and/or the AC amps, volts and phase angles) and used to provide power feedback to the VSG controller speed command generator circuit. During load shed conditions the LST (load shed term) is summed with the actual power out feedback. This provides a composite total “desired power” feedback signal which is used by the VSG speed control where it is compared to a look up table so as to derive the optimum speed command.

The present invention provides a means for charging an ESM while simultaneously providing output power to the load. It should be noted that this “ESM charging power” in addition to the output or load power, maybe sensed at the DC link, or at the ESM itself (Volts and Amperes). Thus, total power required from the engine-generator (load power +ESM charging power) is accurately estimated and fed back to the speed command generator.

A further feature of the invention a means for limiting the PCS inverter AC currents to accomplish high KVA, low power factor transient output amperes, such as are required for induction motor starting, while keeping the output voltage as high as possible.

An additional feature is to provide a PCS bypass option such that the VSG may be operated at a fixed frequency and voltage as a standard generator, thereby providing load power even after an inverter fault. This precludes any of the VSG fuel efficiency enhancements, emissions reductions, or audible noise reductions but does allow for improved overall VSG system reliability and redundancy.

The invention also provides electronically controlled current limiting. This allows the VSG to start and run very difficult, high overload type loads, such as induction motors. For this purpose, the PWM inverter uses AC output PI current loops which are invoked during overload current conditions and are utilized to limit rapidly increasing AC currents due to instantaneous load changes such as “motor starts”.

The present invention applies not only to DC-AC inverters, but also to many other methods of electric power conversion, such as static inverters, and rotary converters (DC-AC motor-generator sets that convert DC electricity to AC electricity), cycloconverters and AC to AC motor generator sets (convert AC electricity to AC electricity). Further the present invention also pertains to other types of “prime movers” than the above mentioned IC (internal combustion) engine, such as turbines, Stirling or any other prime mover which generates differing amounts of power at different RPM's.

The control printed circuit board (PCB) of the present invention acts as a digital signal processor (DSP) based digital controller, in concert with some analog control circuits, and the operating mode can be digitally selected. The control loops have digital (or analog) selected proportional and integral terms, and the feedback circuits have analog phase lead and filter circuits for optimum system tuning. Thus, precise closed loop transient performance is accomplished.

As described herein, grid independent AC power inverters behave as sinusoidal voltage sources and provide power directly to the loads. These present power distribution schemes generally require providing power to both 3-phase and single-phase or line to neutral connected loads. The 3-phase power inverters for DC-AC accomplish this 3-phase plus neutral requirement by isolating the power inverter from the loads with a delta-wye power transformer. For 3-phase inverters equipped with a balanced dual boost regulator and the transformerless output 3-phase power inverter topology and control described herein, this costly transformer is unnecessary. The transformerless power conditioning system is described in U.S. Pat. No. 6,404,655, which is incorporated by reference herein for all purposes.

The invention also provides 3-phase 4-wire output power that is more efficient and substantially less expensive than other distributed power generation technologies. Additionally, a transformerless power inverter system can supply the regulated AC source in single-phase (2 or 3-wire) or three-phase (3 or 4-wire).

The Hybrid VSG/UPS can act as an improved power factor from generator (near unity PF), regardless of the load PF. The PWM inverter converts low PF loads to unity PF at the generator, thereby increasing efficiency and even increasing maximum power out from generator.

In addition, the present invention provides greatly improved non-linear load performance as compared to standard generator. The transformerless PWM inverter has much lower output impedance thereby allowing use of the VSG on 100% non-linear loads with no de-rate. This allows VSG engine/generator to be sized for the load, rather than over sized (the typical approach). This has tremendous cost, fuel efficiency, and emissions benefits primarily due to smaller engine size.

In one embodiment the energy storage module, typically batteries or flywheel, is used to provide overload power. This scheme uses the ESM to feed power into the DC bus thereby offloading the engine and allowing it to climb to the optimum load dependent RPM, thus there is no need to reduce output AC volts to shed engine load and allow RPM adjustment.

The present invention allows ESM power to be added to VSG power thereby increasing total output power capability. It allows for hybrid UPS functionality including inline or offline UPS functionality, when equipped with ESM. The ESM power can be added to VSG power thereby increasing short-term total output power capability. The VSG can be connected to grid and inject power to accomplish peak-shaving (reducing the customer peak load demand from the utility). Allows for VSG to connect to the grid (with VSG engine off) and circulate an adjustable amount of VARS (no real power) for VAR compensation while in standby (waiting for power outage). Allows the VSG/Hybrid UPS to operate as an offline UPS but if grid voltage/frequency falls outside nominal parameters, 100% of power may be connected through the VSG front end (ECA/dual boost) and fed to the load via the PWM inverter. Thereby providing for line voltage or frequency sag and surge by providing a regulated output to the load.

Provides seamless transition from line power to generator backup by operation as an “in-line” UPS. When the line is lost the ESM discharges into inverter DC bus for 3-5 seconds. If the faulty line power persists, the VSG engine begins to start, and input transfer switch closes to generator. Within 10 sec's, the VSG is started and the load is transferred to the generator and away from ESM.

Reduces generator switch gear for synchronization to the AC grid (line). Normally a UPS has redundant synch gear to a parallel generator. By using the hybrid UPS topology of the present invention only one set of switch gear is needed for both the generator and the UPS.

Dramatic reduction in number of UPS storage batteries (ESM) as the generator provides all power to the load after 10 sec's. A typical UPS uses at least 20 times as many batteries to provide only 5 minutes of power. This reduces installation, replacement, and total system costs. Overall benefits include the reduction of installation costs (size, weight etc) for VSG/Hybrid UPS due to reduced number of batteries, and elimination of redundant switch gear. And, active filtering is accomplished by connecting to grid and injecting harmonic cancellation currents while in standby (waiting for power outage).

No warranty is expressed or implied as to the actual degree of safety, security or support of any particular specimen of the invention in whole or in part, due to differences in actual production designs, materials and use of the products of the invention.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A hybrid power converter apparatus, comprising:
a variable speed energy generating device producing differing amounts of power at different speeds;
a hybrid uninterruptible power supply coupled in-line between an AC line and a load, wherein said hybrid uninterruptible power supply is switchably coupled to said variable speed energy generating device, wherein said hybrid uninterruptible power is comprised of a regulator section coupled to an inverter and an energy storage module coupled therebetween.

2. The apparatus according to claim 1, wherein said inverter is selected from the group consisting of: transformerless AC pulse width modulator inverter, DC-AC inverter, static inverter, rotary converter, cycloconverter, and AC-AC motor generator set.

3. The apparatus according to claim 1, wherein the variable speed energy generating device is selected from the group consisting of: internal combustion engine, turbine, micro-turbine and Stirling engine.

4. The apparatus according to claim 1, wherein said regulator section is an enhanced conduction angle dual boost DC bus voltage regulator.

5. The apparatus according to claim 1, further comprising a switch between said inverter and said load.

6. The apparatus according to claim 1, further comprising a switch coupling said hybrid uninterruptible power supply to said AC line.

7. The apparatus according to claim 1, wherein said energy storage module, is selected from the group of devices consisting of: batteries and flywheel.

8. The apparatus according to claim 1, further comprising a bypass switch coupling said AC line to said load.

9. The apparatus according to claim 8, wherein said bypass switch is a bi-directional thyristor.

10. The apparatus according to claim 1, further comprising a bypass switch coupling said variable speed energy source to said load.

11. The apparatus according to claim 10, wherein said bypass switch is a bi-directional thyristor.

12. A method for providing uninterruptible AC power to a load, comprising:
coupling an AC line to a hybrid uninterruptible power supply;
coupling said hybrid uninterruptible power supply to said load, wherein said hybrid uninterruptible power supply comprises a regulator section, an inverter and an energy storage module; and
switchably coupling a variable speed energy source to said hybrid uninterruptible power supply.

13. The method according to claim 12, further comprising feeding the hybrid uninterruptible power supply with said energy storage module.

14. The method according to claim 13, wherein said feeding is derived from a load shed term.

14. The method according to claim 12, further comprising charging said energy storage module while simultaneously providing output power to said load.

15. The method according to claim 12, further comprising steps selected from at least one of the steps consisting of: correcting for sag, correcting for surge, peak shaving, compensating for VAR, active filtering and elimination of active harmonics.

16. A hybrid variable speed generator/uninterruptible power supply device, comprising:
a variable speed generator producing differing amounts of power at different speeds; and
a hybrid uninterruptible power supply coupled in-line between an AC line and a load, wherein said hybrid uninterruptible power supply is switchably coupled to said variable speed generator, and wherein said hybrid uninterruptible power is comprised of a enhanced conduction angle dual boost DC regulator section coupled to an inverter with an energy storage module coupled therebetween.
